(19) United States
(12) Patent Application Publication
(10) Pub. No.: US 2008/0257569 A1
(43) Pub. Date: Oct. 23, 2008

(54) ELECTRONIC DRAFT CONTROL FOR TRAILED IMPLEMENTS

(76) Inventors: Chris Foster, Akron, PA (US); Johnny Keplinger, Quarryville, PA (US); Kevin M. Smith, Narvon, PA (US); John Posselius, Ephrata, PA (US)

Correspondence Address: CNH AMERICA LLC, INTELLECTUAL PROPERTY LAW DEPARTMENT, PO BOX 1895, MS 641, NEW HOLLAND, PA, 17557, US

(21) Appl. No.: 11/736,106

(22) Filed: Apr. 17, 2007

(51) Int. Cl. A01B 63/14; A01B 63/22; G06G 7/00

(52) U.S. Cl. 172/9; 172/7; 701/50

(57) ABSTRACT

A draft load control system for an agricultural tractor towing a trailed, ground-engaging implement that monitors implement height using sensors located on the tractor or sensors coupled to an on-board control communications system and adjusts the implement position in relation to the ground based on draft load, implement height, and tractor wheel-slip to maintain a more accurate, consistent draft load on the tractor while maintaining the implement engaged with the ground and preventing the tractor-implement ground speed from being reduced to zero.

### BACKGROUND OF THE INVENTION

The present invention relates generally to ground-engaging implements towed by agricultural tractors and more particularly to systems and methods for monitoring implement position and controlling the draft load caused by an implement as it is moved across the ground by a tractor.

One of the most common uses of agricultural tractors is to move implements through agricultural fields to cultivate and condition the soil. Implements are commonly connected for towing by the tractor using a three-point hitch or towed using a drawbar. A three-point hitch typically comprises two bottom lift arms, to which the implement is connected in rotary manner to selectively pivot about a given hinge axis; and a top link interposed between the tractor frame and the implement to control the angular position of the implement about the hinge axis. The lift arms are moved by a further actuating cylinder (or cylinders) interposed between the tractor frame and the lift arms, movement of the lift arms raising and lowering the implement with respect to the ground. Similarly, many trailed implements include one or more wheels pivotably connected to the implement in a manner to raise and lower the implement with respect to the ground offering an alternative method for altering implement position. Movement of the lift arms and/or implement-attached wheels is used to establish implement position with respect to the ground.

It is desirable and sometimes critical for today's farming practices, to control the quality of cultivation performed by various ground-engaging devices attached to the frame of the implement. As the implement frame is lowered closer to the ground, the ground-engaging devices or tools dig or cut deeper into the soil and the draft load increases. As the frame is raised higher above the ground, the ground-engaging devices dig more shallowly into the soil and the draft load decreases. Some implements must remain engaged with the ground during operation such that the tools do not become disengaged from the ground, which is usually implemented by specifying a minimum ground engagement depth. Typically, the operator has a manually operable device in the cab of the tractor that is manipulated to raise and lower the implement accordingly, whether by the three-point hitch, the implement wheels, or a combination of the two. When the operator finishes manipulating the device, the implement remains in the position set by the operator, but will not, however, maintain a desired depth of engagement or implement draft load as the tractor and implement move across the ground. Changes in field contour or soil hardness cause the depth of engagement and/or the draft load to change. To maintain the implement in a position to achieve a consistent draft load or depth of engagement, the operator must periodically look rearward and observe the implement. If the implement has drifted away from the desired depth of engagement, the operator must manipulate the depth control device to reposition the implement until the desired depth of engagement is reestablished. Similarly, changes in draft load may cause the engine to be bogged down, requiring operator adjustment of implement position to avoid stalling the engine. In other situations, increasing draft load may cause increased wheel slippage leading ultimately to a halting of vehicle motion. Therefore, even in systems in which the operator can adjust the implement position, periodic, or semi-constant under some field conditions, visual monitoring of the implement position and adjustment of the hitch height input device is necessary to maintain the desired draft load on the tractor.

The concept of electronic draft control (EDC) has been applied to three-point hitch mounted implements. These EDC systems alleviate the need for manual operator hitch adjustments by controlling the position of the connected implement in response to loads applied to the tractor by the implement. The control systems allow the depth of engagement to be adjusted so that a constant draft load is applied to the tractor to smooth tractor operation. Such control systems typically rely on one or more measuring devices to sense the draft loads applied to the hitch by the implement and the implement position, and then adjust the implement position in response.

Drawbar trailed implements are not typically the focus of EDC systems even though many tractor operations, including tillage, can be performed using drawbar towed implements. Efforts to automatically control the draft load by repositioning a trailed implement to vary its depth of ground engagement have been problematic. Measuring implement height and providing a height signal to the EDC system generally requires locating a sensing device on the implement. Adding such sensors to implements subjects those sensors to harsh operating conditions which lead to increased failure rates.

Depth control alone is not sufficient to control draft load with the required precision. Changing terrain or soil conditions may also affect draft load on the tractor which has led to including a measure of the draft load into the control logic on many EDC systems. Numerous methods have been used to monitor the draft load on a tractor including direct measure using special draft pins fitted in the drawbar, monitoring hydraulic pressure in hydraulically cushioned drawbars, monitoring cushion deflection in spring or elastic material cushioned drawbars, and derivation of draft load from engine and/or wheel torques.

Even depth control combined with draft load measurement is still insufficient under some conditions. Conventional methods of draft control are based on ideal traction conditions for the drive wheels. If wheel slippage occurs, the response of conventional EDC systems is generally counterproductive as excessive slippage generally causes a decrease in the draft load. Normal EDC system response to a decrease in draft load is to lower the implement in the ground causing an increase in the implement tools engagement with the ground to increase the draft load. Such action when wheel slip is present can, if undetected or unmonitored, lead to stalling the tractor-implement combination.

It would be a great advantage to provide an improved system for controlling the depth of ground engagement (implement height) and therefore the draft load imposed on the tractor by a trailed implement in a manner to maintain a constant draft load on the tractor. Further advantages would be realized if the draft load control system would function for any connected implement by locating the height sensing apparatus on the tractor instead of the implement or by providing a convenient means of obtaining a signal from an on-implement sensing apparatus. Still further advantages would be realized if the draft load control system distinguished changes in sensed draft load resulting from wheel slip from actual changes in draft load caused by changing ground conditions. These and other advantages are provided by the draft control system described below.

### SUMMARY OF THE INVENTION

Accordingly, it is an object of the present invention to provide an electronic draft control system for an agricultural tractor towing trailed, ground-engaging implements.

It is a further object of the present invention to provide an electronic draft control system for an agricultural tractor towing trailed, ground-engaging implements that adjusts the implement position in relation to the ground to maintain a more accurate, consistent draft load on the tractor.

It is a further object of the present invention to provide a draft control system for an agricultural tractor towing trailed, ground-engaging implements that adjusts actuators on the coupled implement to maintain a constant load on the tractor engine.

It is a further object of the present invention to provide an automated draft control system for an agricultural tractor that utilizes existing parameter signals and communications systems on the tractor to the extent practicable thereby reducing the need for additional sensors and signal circuits.

It is a further object of the present invention to provide a draft control system for trailed implements that determines implement position without requiring position or other sensors to be provided on the trailed implement.

It is a further object of the present invention to provide a draft control system for an agricultural tractor towing trailed, ground-engaging implements that monitors drive wheel slip and adjusts implement position in response to detected excessive wheel slip to maintain tractor motion.

It is a further object of the present invention to automate a draft control system for towed, ground-engaging implements thereby alleviating the need for an operator to manually monitor and control implement position to maintain a more consistent draft load on the tractor thereby reducing operator fatigue and increasing productivity.

It is a further object of the present invention to provide a draft control system for an agricultural tractor towing trailed, ground-engaging implements capable of maintaining ground engagement of the implements within pre-determined limits thereby preventing the system from raising the implement completely out of the ground during certain tillage operations, such as those involving the injection of fertilizers and the like into the ground.

It is a still further object of the present invention to provide an agricultural tractor draft control system for towed implements that is durable in construction, inexpensive of manufacture, carefree of maintenance, easily assembled, and simple and effective to use.

These and other objects are achieved by providing a draft load control system for an agricultural tractor towing a trailed, ground-engaging implement that monitors implement height using sensors located on the tractor or communicating with the control system using an on-board tractor control communication system and adjusts the implement position in relation to the ground based on draft load, implement height, and tractor wheel-slip to maintain a more accurate, consistent draft load on the tractor while maintaining the implement engaged with the ground and preventing the tractor-implement ground speed from being reduced to zero.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a side view of an agricultural tractor towing a ground-engaging implement by a drawbar in accordance with the present invention;

FIG. 2 is a schematic diagram of a drawbar load control system illustrating the control inputs and outputs of the preferred embodiment;

FIG. 3 is a schematic diagram of a drawbar load control system using hydraulic fluid flow to the implement positioning apparatus to derive implement position; and

FIG. 4 is a schematic diagram of a drawbar load control system using the position of an electro-hydraulic remote valve to derive implement position.

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right,” “up” or “down,” or “top” or “bottom” are used as a matter of mere convenience, and are determined by standing at the rear of the machine facing in its normal direction of travel. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all of the figures.

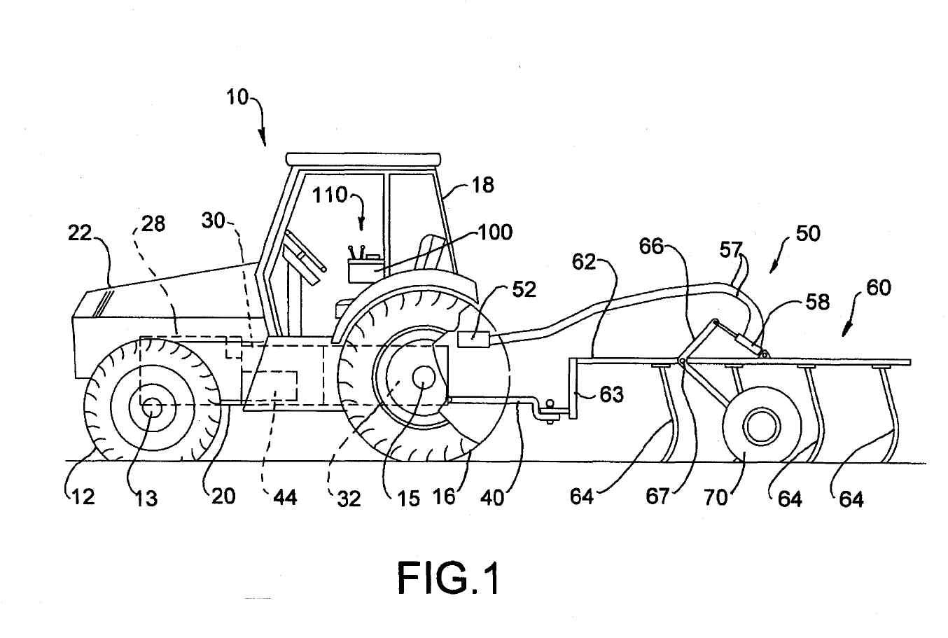

Referring now to FIG. 1, there is illustrated an agricultural tractor 10 having a pair of front wheels 12 connected to opposing ends of a front axle 13, a pair of rear wheels 16 connected to opposing ends of a rear axle 15, a chassis 20, and an operator's cab 18 from which the tractor can be comfortably operated. The rear wheels 16 of tractor 10 are driven by tractor engine 28, which is disposed under a forwardly extending hood 22 located just in front of the operator compartment (cab) 18. A transmission 30 is fixed to the engine 28 and includes a gearbox that provides a plurality of gear ratios. A differential 32 is fixed to the rear of the transmission 30 and transfers power to at least a pair of rear wheels 16, generally through rear axle 15. Engine 28, transmission 30, and differential 32 collectively comprise chassis 20. In an alternative configuration, a separate frame or chassis may be provided to which the engine, the transmission, and the differential are coupled, a configuration common in smaller tractors. Still other tractor configurations may drive all wheels on the tractor, use an articulated chassis to steer the tractor, or rely on tracks in lieu of wheels. The present invention is readily adaptable to most agricultural tractor application regardless of the tractor configuration.

Tractor 10 also typically includes auxiliary systems coupled to engine 28. One such auxiliary system is a hydraulic system 44 which provides a source of pressurized hydraulic fluid for powering various actuators used for driving and/or positioning implements and other detachable equipment. Common hydraulically-powered apparatus include a three-point hitch (not shown) and one or more electro-hydraulic remote (EHR) valves 52 for controlling the flow of hydraulic fluid to actuators located off of the tractor, such as the implement positioning apparatus 50 shown.

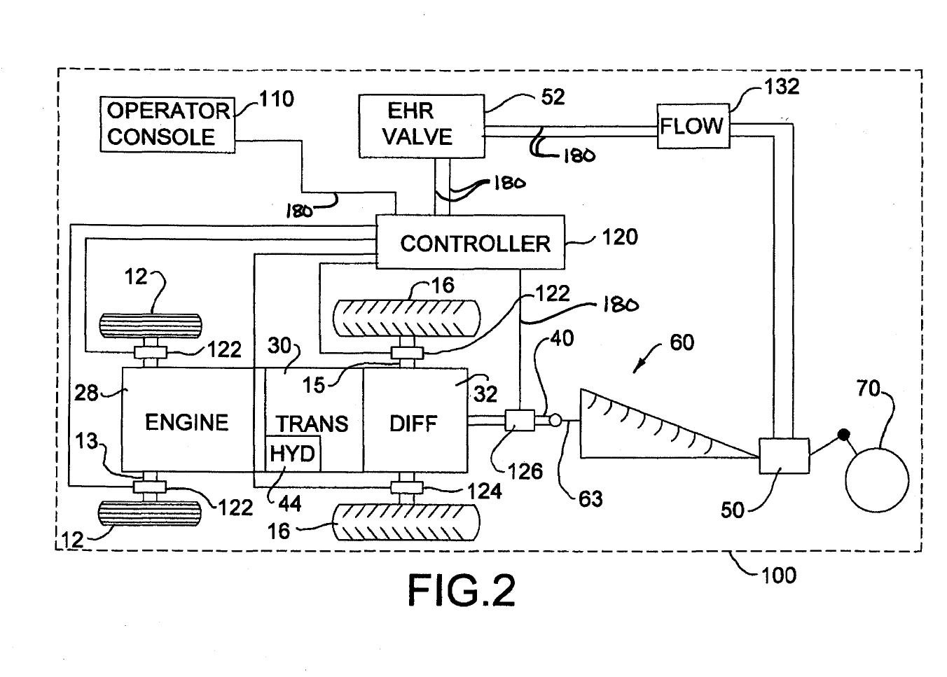

Tractor 10 is shown towing implement 60. Tractor 10 includes drawbar 40 which provides a connection point for hitch 63 on implement 60. Height adjustment and thereby depth of engagement for towed implement 60 is controlled by an implement positioning apparatus 50 for raising and lowering frame 62 with respect to the nominal surface of the ground. Implement wheels 70 are rotationally coupled to a lower end of mechanical link 66. Link 66, in turn, is pivotally coupled to the frame 62 at pivot point 67. Link 66 is coupled to frame 62 to pivot clockwise or counterclockwise with respect to the frame 62 about pivot point 67. Link 66 is pivoted by hydraulic cylinder 56, which is coupled to and between the upper end of link 66 and frame 62. Movement of hydraulic cylinder 56 is controlled by the EHR valve 52 which is connected to hydraulic cylinder 56 by hoses 57. The EHR valve 52 receives selective input from the operator console 110 or the draft control system, shown as reference item 100 in FIG. 2. When cylinder 56 extends, it rotates link 66 counterclockwise with respect to the chassis. Due to the rearward angle at which the lower portion of link 66 extends, this counterclockwise rotation causes wheel 70 to rise upward toward frame 62. As a practical matter, since wheel 70 is typically resting on the ground when cylinder 56 is extended and retracted, wheel 70 does not actually “rise” or “fall.” Instead, frame 62 rises or falls with respect to the wheel, and hence with respect to the ground. Thus, whenever hydraulic cylinder 56 extends, frame 62 lowers downwardly towards the ground and whenever hydraulic cylinder 56 retracts, frame 62 rises upwardly away from the ground. Using the frame 62 as a reference point, however, one can say that the wheels are “raised” or “lowered.” It should also be noted that implement positioning apparatus 50 may include one or more wheels 70, links 66 and cylinders 56 for vertically altering the implement position.

Implement 60 has several ground-engaging implements or tools 64 that are coupled to and extend downward from frame 62. These tools 64 may include, for example, plows, rakes, harrows, or other ground cultivating devices. Still other tool examples include ground injectors, such as those used to apply manure slurry or liquid fertilizers below the ground surface. Whenever frame 62 is raised or lowered with respect to the ground, the depth of penetration of tools 64 is also increased or decreased. Thus, whenever the actuator's hydraulic cylinder 56 extends, tools 64 extend further toward or into the ground. Whenever the position actuator's hydraulic cylinder 56 retracts, tools 64 move further from, or out of, the ground. As can be expected, changes in depth of penetration of the implement 60 into the ground affect the tractive effort (draft) required of the tractor to pull the implement through the ground. Ground injector tools impose additional requirements on the control system in that these tools impose minimum ground engagement limits during the injection activities. The operator, if the implement height is manually controlled, or the draft control system, if the implement height is being automatically controlled, should not lift the implement to a position such that the tools 64 completely disengage the ground whenever injection is in process.

Systems known in the prior art typically monitor wheel torques and use the measurement thereof as an input to implement position control. Such systems typically use drivetrain torques to derive the draft loads applied upon the tractors by the implement as it is towed through the field. By comparing the instantaneous wheel torque derived running draft load to a draft load setpoint, the control system generates a draft control signal that is communicated to implement positioning apparatus 50 so that implement 60 will be repositioned to maintain a generally constant draft load on the tractor. The disadvantage to this approach is that wheel torque varies predictably with draft load only as long as minimal slippage occurs between the drive wheels and the ground. Wheel torque generally decreases when a drive wheel slips in excess of approximately 20 percent. Conventional control systems, upon sensing a decrease in wheel torque, incorrectly interpret the change as a reduction in draft load and generate control signals to move the implement deeper into the ground. This response usually results in an even greater degree of wheel slip, ultimately leading to stalling of the tractor-implement combination. Similar disadvantages are present in systems relying on a direct draft load measuring apparatus but lacking control input for the presence of wheel slippage.

Referring now to FIG. 2, tractor 10 is equipped with an electronic draft control (EDC) system, designated generally by the reference numeral 100 for managing the vertical position of implement 60 relative to the ground that overcomes the above disadvantages. While EDC system 100 may include more or fewer of the elements shown in FIG. 2, it typically includes at least one controller 120, one or more drive speed sensors 124 coupled to the drive axles or other portion of the driveline to determine apparent vehicle speed, one or more true ground speed sensors 122 coupled to the front, non-driven axle 13 for determining the true vehicle speed relative to the ground, and a draft force sensor 126 for measuring the magnitude of the generally instantaneous draft load force on the drawbar, referred to herein as the running draft load. Controller 120 is preferably a digital controller capable of receiving software programming instructions which allows the controller to perform a wide array of tasks within the capability of a single apparatus. A plurality of control functions may be programmed into the controller, with each separate function commonly referenced as a controller for that specific function.

The EDC system 100 may be incorporated into an overall control system of the tractor 10. Such control systems typically integrate numerous individual control functions into a larger, more powerful digital electronic processor networks which receive inputs from various sensors and monitors using a serial communications bus, shown as item 180 in FIG. 2, and provide control commands using the same communications network. A key advantage of such systems is the ability for input and output signals to be shared among multiple control functions, thereby reducing the need for dedicated hardware for each individual function being controlled. The communications bus (CAN bus) is preferably a controller area network bus such as the bus defined in the SAE J1939 standard. Individual communications circuits within the communications bus are preferably Siemens or Motorola brand CAN bus controller circuits that are either integrally formed with the controllers or are coupled to the controllers. By using the existing CAN bus, the present invention may obtain the necessary input information without the need to employ additional, task-specific sensing circuits. These preferences are based upon actual field test results, and reflect choices made thereon. However, it should be obvious that components other than these will work, and certainly improvements by other manufacturers will be made and may prove even more suitable than those specifically identified herein. Additionally, while a serial communications protocol is described, use of other protocols (e.g., parallel) are equally suitable and thus not precluded by this invention.

Speed sensors 122, 124 may include a variable inductance magnetic pickup sensor that detects the rotational velocity of front wheels 12 and rear wheels 16, respectively, and generate speed signals representative thereof. These speed signals are preferably transmitted to a controller 120 by the CAN bus communications network on tractor 10. Alternatively, communications may utilize dedicated electronic circuit loops. In the event that front wheels 12 are driven, an alternate sensor for monitoring the true speed of tractor 10 with respect to the ground is necessary. One such sensor is a radar device mounted to tractor 10 which emits radar signals toward the ground and receives a portion of the signals rebounding from the ground to determine the ground speed of tractor 10. The radar device then generates a speed signal representative of the true ground speed and transmits this signal to the EDC system controller 120. As another alternative, ground speed sensor 122 could sense the rate of rotation of an optional non-driven fifth wheel (not shown) of tractor 10 used for sensing ground speed. Ground speed sensor 122 could also sense laser beam signals or externally-generated signals (e.g., signals relayed to tractor 10 from an external radar station) to measure the speed of tractor 10 with respect to the ground.

Control of the position of implement 60 is generally based upon information relating to the sensed generally instantaneous implement position and running draft load force. EDC system 100 therefore also includes one or more sensors for sensing the running draft load force as the tractor propels the implement through the ground and one or more sensors for measuring the running vertical position of implement 60 relative to the nominal surface of the ground. Draft load sensor 126 typically includes at least one resistance strain gauge applied to a link positioned in line with the drawbar 40, which generates a direct measurement running draft load signal representative of the force exerted on the drawbar 40 by the implement 60. This running draft load signal is transmitted to the controller 120, preferably via the CAN bus 180. In the known art, implement vertical position is commonly sensed by a rotary or linear potentiometer or linear variable differential transformer (LVDT) coupled to the implement positioning apparatus 50 that detects the relative position(s) of linkages within the positioning apparatus 60 to determine and generates a position signal representative of the generally instantaneous height of the implement, referred to herein as the implement running height. Such apparatus require subjecting sensitive sensors to the harsh service conditions experienced on the implement. In the present invention, implement running height is determined by monitoring action of the EHR valve 52, which is responsible for moving the implement positioning apparatus 50, and providing programming in controller 120 for determining the implement running height based on the flow of hydraulic fluid to the positioning apparatus 50 controlled by movement of the EHR valve 52.

For certain operations it may be necessary to set height limits for the EDC system operation. Examples of such operations include implements having anhydrous injectors, manure injectors, and the like during which the implement tool must remain sufficiently engaged with the ground for the implement to properly perform. Other applications might require that implement engagement in the ground be limited to certain maximum depths as required by certain planting or harvesting operations. Even if the EDC system requires that the implement be raised or lowered to a higher position outside of the defined limits to maintain the desired the draft load, the EDC system will prevent such movement that would result in operation with the tools engaged too deep or too shallow in the soil.

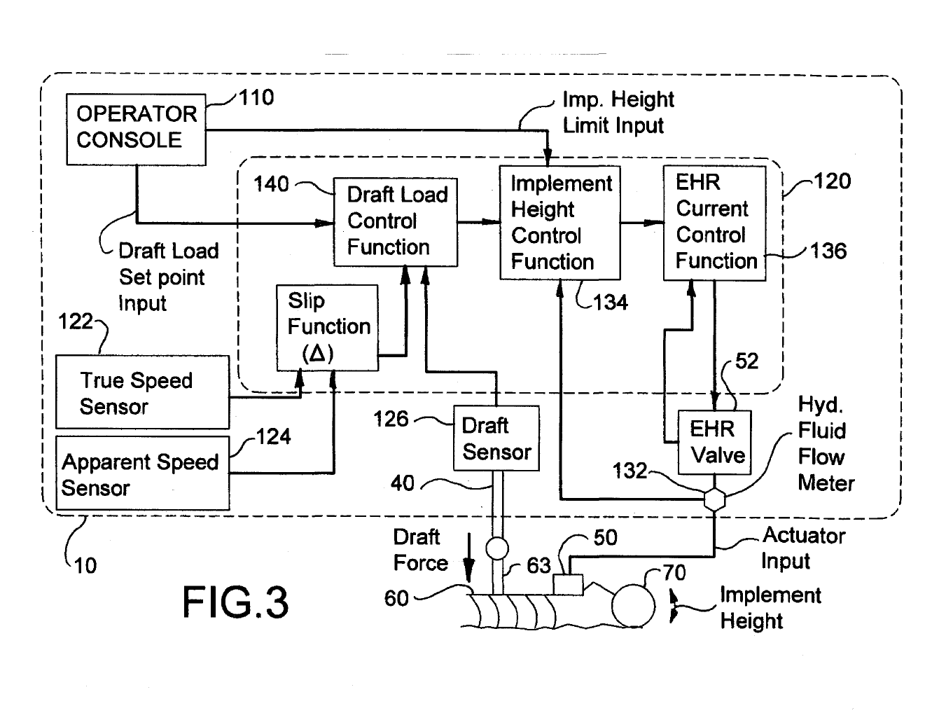

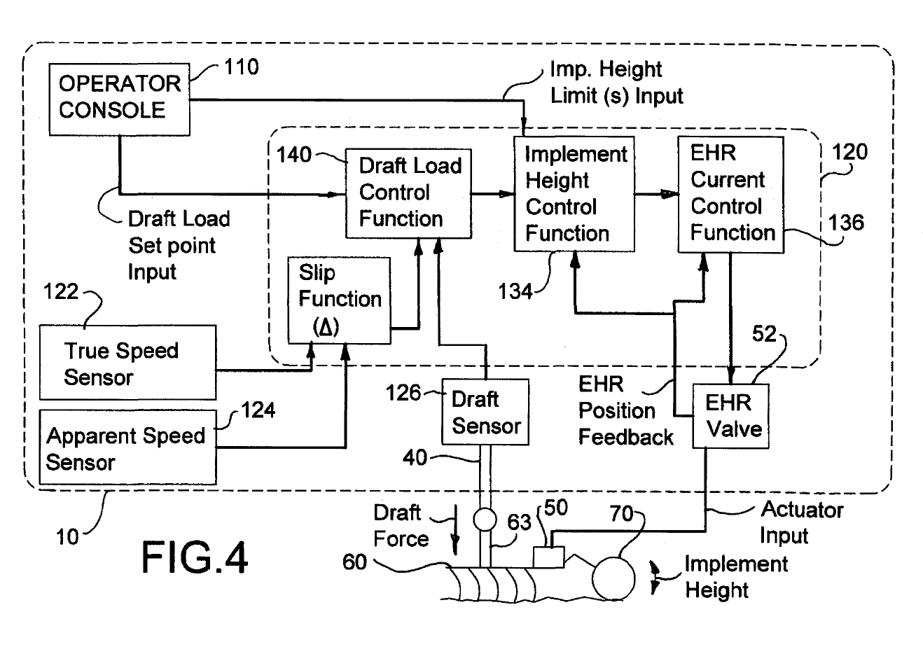

In a first alternative of the present invention, the hydraulic flow through the implement positioning apparatus 50 can be monitored to allow the running height of the implement to be determined. Flow can be measured directly using a flowmeter 132 and then using the characteristics of the hydraulic cylinder 58, movement of the cylinder 58 can be determined which enables implement running height to be calculated. In a second alternative embodiment, the position of the EHR valve 52 can be monitored and, given the valve characteristics and the hydraulic system pressure, a hydraulic flow calculated. Once hydraulic flow is identified, implement running height based on the resultant of the hydraulic cylinder 56 can be determined. The advantage of these embodiments is that implement running height may be determined without the use of specific sensors located on the implement. Sensing devices are located in the comparatively milder environment of the tractor which improves the overall durability and reliability of the system. Additionally, these sensors may already exist on many tractors such that implementing the present invention on an existing tractor does not require the addition of a complete set of task-specific sensors, thereby minimizing the cost of the invention in the overall tractor production cost. Typical schematics are shown in FIGS. 3 and 4.

In a second alternate embodiment, a towed implement having an on-board controller, may be communicatively coupled to the tractor controller using the CAN bus. In such an implement, a protective enclosure would exist to protect sensitive electronic components from the harsh conditions to which the implement is subjected. An implement height sensor could easily be incorporated on such an implement, if not already present, and communicated to the towing tractor via the existing CAN bus communication link between the implement and tractor.

Other alternatives for measuring draft force are contemplated by this invention as these may be easily implemented using available inputs and control outputs on the tractor control system and CAN bus network. By using a sensor or a plurality of sensors to measure drawbar force, a running draft load value can be measured or derived for use by the EDC system 100. Such examples include measuring pressure in a hydraulic cylinder used in a hydraulically suspended drawbar or measuring displacement of a suspended or cushioned drawbar mount. Another indirect method requires monitoring engine performance and other engine-powered vehicle sub-systems to determine engine torque, power, and speed, and then using the performance information to derive draft load based on engine power. Yet another indirect indication of draft load can be obtained by monitoring transmission performance to determine ground or wheel torque.

Conventional draft control systems using direct or indirect measurement of the running draft force generally assume no slippage occurs between the ground-engaging drive surface, whether a wheel or a track, and the ground. The controller 120 in the present invention includes an input measure of the amount of wheel slip occurring to improve draft control performance of the system. When the EDC system 100 detects a change in the running draft load on the vehicle, the system 100 determines whether the change in running draft load is accompanied by a change in the magnitude of wheel slip. A decrease in draft load accompanied by an excessive increase in slip is indicative of a drive wheel or surface spinning instead of an actual reduction of the running draft load. Under these conditions, the normal response to lower the implement thereby increasing the draft load would only cause increased slip which could lead to stalling the vehicle. Instead, when a decrease in running draft load occurs in conjunction with an increase in wheel slip, the controller momentarily raises the implement, within pre-defined limits, until the wheel slip returns to within its predefined acceptable limits whereupon the controller can return the implement to a position providing the desired draft load.

By including wheel slip, the EDC system can determine if a reduction in the drawbar loading is due to an actual decrease in the draft or due to reduced traction (increased slip of the vehicle drive surfaces). The EDC system can determine the best control action to resume optimal performance and enhance overall efficiency of the vehicle-implement combination. Without the slip signal, if the drawbar forces are reduced due to traction conditions, the EDC system response upon decreased draft load will cause the implement to be pushed deeper into the ground in an effort in increase draft load. This will only cause the wheel slip to increase further and could, in a worst case scenario, cause the vehicle to become stuck. With the slip signal, if a reduction in drawbar force is detected along with a high level of wheel slip, the EDC system can temporarily lift the implement to restore wheel traction before resuming normal operation.

The EDC system 100 also includes an operator input apparatus 110 for allowing the operator to engage or disengage the electronic draft control system, define limitations of certain parameters, or alter the programming. The operator input apparatus 110 is typically a digital electronic device which provides the capability to control and adjust the system and may also provide display capability to inform the operator of the status of the system, implement position, and the like, during operation.

There are several methods for enabling/disabling the EDC system. Perhaps the easiest is a manual method whereby the operator engages the EDC system as the vehicle-towed implement combination begins to travel along a tillage path (row) and subsequently disengages the system upon reaching the end of the row. Another method is to define limits on the height of a trailed implement such that lifting the implement above a predefined first limit (by manually manipulating the EHR valve 52) disables the system. In such an approach, the EDC system could be automatically re-engaged as the implement is lowered below a predefined second limit. The values of the first and second limits may be equal or may differ by a small amount depending upon the direction the implement is moving at the time to allow for delayed system response time or to otherwise allow the system response to be optimally tuned. Still another method is engage the EDC system by actuation of the vehicle EHR such that when the implement is manually lowered to a depth within a defined tillage range, the EDC system would automatically engage to assume control of the implement vertical position. Still other alternatives for engaging or disengaging the EDC system include disengagement when ground speed exceeds a predefined limit or when drawbar force falls below a predefined limit. On vehicles equipped with vehicle autoguidance systems, the EDC system could be communicatively connected to the autoguidance system such that the EDC system would be engaged and disengaged based on position of the vehicle/implement within the field; the EDC system could be automatically disengaged while the vehicle traversed headlands or other non-tilled areas of the field.

Now referring to FIGS. 3 and 4, shown are two alternative control loops for the present control system which utilize existing hydraulic and other systems typically located onboard of the tractor. The controller function shown in FIGS. 3 and 4 are generally provided by means of software programming instructions executed within controller 120 of the EDC system 100. The EDC system controller 120 generally comprises three nested functional control loops, including a draft controller 140, an implement height controller 134, and an EHR valve current controller 136. Draft controller 140 receives a desired draft load input from the operator, typically via operator input console 110, and a feedback signal from the draft load sensor 126 representing the generally instantaneous magnitude of the draft force (running draft load). The values of the running and desired draft loads are compared to generate an error signal, also referred to as a demand signal. The draft load demand signal of the draft controller 140 may be expressed in terms of an increase, decrease, or no change in the running draft load. The draft load demand signal is directed to the implement height controller which manages implement height based on the demand to increase, decrease, or maintain the running draft load. Under steady state conditions, the draft load demand signal may be zero and the system would maintain the implement at the then-present running implement height. In the event the value of the running draft load differs from the value of the desired draft load, the draft load demand signal will direct the implement height controller 134 to alter implement vertical position and return the error signal to substantially zero.

The implement height controller 134 manages the vertical position of the implement by receiving, whether by direct or indirect measurement, a signal representing the generally instantaneous vertical position of the implement (running height), comparing the position to the draft load demand signal communicated by draft load controller 140, and generating a valve control signal which is communicated to the EHR valve current controller 136. Current controller 136 manages the position of the EHR valve (or valves) 52 by regulating the electrical current supplied to the EHR valve 52. Movement of the EHR valve 52 manages the flow of hydraulic fluid from the hydraulic system 44 on the vehicle to the implement positioning apparatus 50.

The EDC system of the present invention may be implemented on a vehicle in a manner such that the attached implement need not have a sensor for implement running height, as illustrated in FIGS. 3 and 4. The hydraulic flow through the actuation cylinder can be monitored to provide the running height of the implement. In FIG. 3, a first embodiment of a method for determining implement running height is illustrated wherein the implement height is derived by incorporating a flowmeter (reference number 132 described above in relation to FIG. 2) into the hydraulic lines connecting the EHR valve 52 to implement positioning apparatus 50. The volume of hydraulic fluid supplied to or received from the implement positioning apparatus 50 can be correlated to the running vertical position of the implement by programming within the controller 120. In a second embodiment, the flow of hydraulic fluid through the EHR valve 52 is derived by monitoring the position of the valve 52. The position of the EHR valve along with the valve characteristics and the hydraulic system pressure allow the hydraulic fluid flow to be calculated which is then used to derive implement running height.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions.

1. A draft load control system for adjusting the vertical position of a ground-engaging implement relative to the nominal surface of the ground as the implement is being towed by a self-propelled vehicle, the vehicle having at least one ground-engaging drive surface for propelling the vehicle along the ground and an on-board control communication system, the implement having a connected implement positioning apparatus for vertically moving the implement is response to a position control signal, the draft load control system comprising:
an input apparatus for receiving a draft load setpoint and an implement height setpoint from an operator and generating a corresponding draft load setpoint signal having a value and an implement height setpoint signal having a value;
an implement height sensing apparatus for measuring the vertical position of the implement relative to a nominal surface of the ground and generating a running height signal having a value generally representative of an instantaneous implement height;
a draft load measuring apparatus for measuring the draft load applied on the vehicle by the implement as the implement is propelled along the ground by the vehicle and generating a running draft load signal having a value varying with the generally instantaneous magnitude of the draft load; and
a controller disposed on the vehicle communicatively coupled to said input apparatus, said implement height sensing apparatus, and said draft load measuring apparatus by said communication system, said controller receiving said draft load setpoint signal, said implement height setpoint signal, a hitch position signal, said implement running height signal, and said running draft load signal, deriving, in accordance with its programming, an implement position control signal, and sending said control signal via said communication system to said implement positioning apparatus, wherein said controller is configured to maintain a substantially constant draft load on the vehicle by varying the implement height with respect to the ground surface.

2. The control system of claim 1, wherein said on-board control communication system comprises a digital electronic serial communications bus.

3. The control system of claim 2, wherein said draft load measuring apparatus is a load sensor connected to the coupling between the vehicle and the implement.

4. The control system of claim 3, wherein said draft load measuring apparatus is a draft pin.

5. The control system of claim 1, further comprising at least one implement height limit received by said controller wherein said controller manages said position control signal such that said implement height is maintained within said at least one height limit.

6. The control system of claim 1, wherein said implement height sensing apparatus is disposed on the vehicle.

7. The control system of claim 6, further comprising a remote hydraulic valve connected to the vehicle for regulating a flow of hydraulic fluid to said implement positioning apparatus, said hydraulic valve selectively positionable between opposing first and second positions, said valve having a valve sensor for determining the position of said hydraulic valve in relation to said first and second positions and generating a signal indicative of said control position, said controller upon receiving said control position signal, deriving, in accordance with its programming, said implement height signal value based on said flow of hydraulic fluid through said hydraulic valve resulting from the position of said hydraulic valve.

8. The control system of claim 7, further comprising at least one implement height limit received by said controller wherein said controller manages said position control signal such that said implement height is maintained within said at least one height limit.

9. The control system of claim 6, further comprising a remote hydraulic valve connected to the vehicle for regulating a flow of hydraulic fluid to said positioning actuator and a flow sensor for measuring said flow of hydraulic fluid to said positioning actuator, said flow sensor generating a signal indicative of said flow of hydraulic fluid to said positioning actuator, said controller, upon receiving said flow signal, deriving, in accordance with its programming, said implement height signal value based on a flow of hydraulic fluid to said positioning actuator through said control valve.

10. The control system of claim 9, further comprising at least one implement height limit received by said controller wherein said controller manages said position control signal such that said implement height is maintained within said at least one height limit.

11. The control system of claim 2, wherein said implement height sensing apparatus is disposed on the implement and communicatively coupled to said controller via said control communications system.

12. The control system of claim 1, further comprising a true vehicle speed sensor, an apparent speed sensor, and a drive slip measuring apparatus for measuring the difference between the apparent vehicle speed and the true vehicle speed and generating a drive slip signal having a value representing the magnitude of the difference, said drive slip signal, upon being communicated to said controller, being used to modify said position control signal to maintain a generally constant draft load while maintaining drive slip within predefined limits.

13. The control system of claim 12, wherein said controller derives said implement position control signal such that management of implement height is influenced by said drive slip signal such that an increase in said drive slip signal value received by said controller exceeding a predefined threshold in conjunction with a decrease in said draft load signal value causes said controller to momentarily alter said implement position control signal in a manner inverse to a normal response until said drive slip signal value decreases to less than said predefined threshold.

14. A method for controlling the draft load of a ground-engaging implement towed by an agricultural tractor, the method comprising the steps of:
providing a ground-supported agricultural tractor having an engine for motive power, at least one ground-engaging drive surface, a hydraulic system having at least one remote hydraulic valve, an on-board control communication system, and an operator's platform;
providing a ground-engaging implement connected to the tractor and thereby propelled by the tractor, the implement having an implement positioning apparatus movable in upward and downward directions responsive to an implement position control signal which manages the remote hydraulic valve to direct a flow of fluid from the tractor hydraulic system;
providing a draft load sensor for measuring a running draft load applied on the tractor by the implement as it is towed across and engaged with the ground;
providing an implement height sensor for determining the running height of the implement relative to the nominal surface of the ground;
providing a draft load controller disposed on the tractor for managing the implement position, the controller being communicatively coupled to the implement height sensing apparatus and the draft load measuring apparatus by the communication system;
providing an operator input apparatus at the operator platform to establish at least a desired draft load value and communicate the desired draft load value to the load controller via the communication system;
setting the desired draft load value using the operator input apparatus;
communicating the desired draft load value to the controller;
operating the tractor to cause the implement to engage the ground thereby creating an actual running draft load on the tractor;
generating a running draft load value by the draft load sensor;
generating a running implement height value by the implement height sensor;
communicating the running draft load value and the running implement height value to the controller;
comparing the running draft load value to the desired draft load value;
calculating an error signal based on the difference between the running draft load value and the desired draft load value;
generating an implement position control signal having a value,
communicating the implement position control signal to the implement position actuator; and
changing the implement position based on the value of the implement position control signal thereby causing the error signal to be substantially zero and managing a substantially constant draft load on the tractor.

15. The method of claim 14, wherein said on-board control communication system comprises a digital electronic serial communications bus.

16. The method of claim 15, further comprising the steps:
setting at least one implement height limit having a value using the operator input apparatus;
communicating the at least one implement height limit value to the controller;
comparing the implement running height value to the at least one implement height limit value;
comparing the implement position control signal value to the difference between the implement running height value and the at least one implement height limit;
calculating whether the implement position control signal will cause the implement running height value to exceed the at least one implement height limit value; and
modifying the implement position control signal to maintain the implement running height within the at least one implement height limit value.

17. The method of claim 15, wherein said implement height sensing apparatus is disposed on the vehicle.

18. The method of claim 17, wherein the implement running height value is derived by monitoring the flow of the hydraulic fluid through the remote hydraulic valve to the implement positioning apparatus.

19. The method of claim 18, wherein the flow of hydraulic fluid is derived from the position of the remote hydraulic valve.

20. The method of claim 18, wherein the flow of hydraulic fluid from the remote hydraulic valve to the implement positioning apparatus is measured directly.

21. The method of claim 15, wherein said implement height sensing apparatus is disposed on said implement and communicatively coupled to said controller via said control communications system.

22. The method of claim 15, further comprising the steps:
providing a true vehicle speed sensor for measuring the speed of the tractor relative to the ground;
providing an apparent speed sensor for measuring the speed of the drive surface;
setting a drive slip threshold value using the operator input apparatus;
communicating the drive slip threshold value to the controller;
comparing the true speed and the apparent speed to determine the difference, the difference being a drive slip value communicated to the controller;
comparing the drive slip value to the drive slip threshold value; and
modifying, by the controller in accordance with its programming, the implement position control signal when the drive slip value exceeds the drive slip threshold value such that the implement is momentarily raised with respect to the ground, within the at least one implement height limit, until the drive slip value is reduced to less than or equal to the drive slip threshold value whereupon the controller adjusts the implement position control signal to readjust implement height to a position whereby the error signal is substantially zero thereby causing a substantially constant draft load on the tractor.
